(19) United States
(12) Patent Application Publication
(10) Pub. No.: US 2026/0001462 A1
(43) Pub. Date: Jan. 1, 2026

(54) SEAT WITH UNIVERSAL BASE AND DEDICATED UPPER PORTIONS

(71) Applicant: GM GLOBAL TECHNOLOGY OPERATIONS LLC, Detroit, MI (US)

(72) Inventors: Edward Thaddeus Kuczynski, Ann Arbor, MI (US); Daniel J. Edwards, New Baltimore, MI (US); Stacy Nicole Amin, Clarkston, MI (US); Rami Z. Sayed, Farmington Hills, MI (US); Matthew Cwynar, Pinckney, MI (US)

(73) Assignee: GM GLOBAL TECHNOLOGY OPERATIONS LLC, Detroit, MI (US)

(21) Appl. No.: 18/754,163

(22) Filed: Jun. 26, 2024

(51) Int. Cl. B60N 2/70; B60N 2/58

(52) U.S. Cl. CPC B60N 2/7017; B60N 2/5891

(57) ABSTRACT

A method includes forming a lot of universal foam support bases with a base compression strength, upper surfaces, and lower surfaces configured for mounting to a frame; determining desired parameters for a desired seat; constructing pieces of trim to form an outer surface; contacting each piece of trim with a foam material to form intermediate products, wherein each intermediate product includes a foam layer and trim layer, wherein the foam layer has a thickness of at least forty millimeters, and wherein the foam layer has an upper compression strength less than the base compression strength; processing the intermediate products to form molded upper seat portions having a uniform shape, wherein a thickness of each intermediate product ranges from less than ten millimeters to at least forty millimeters; and mounting each molded upper seat portion directly to a respective universal foam support base to form the seats.

### INTRODUCTION

The technical field generally relates to vehicle seats for motor vehicles, and more particularly to a seat formed from a universal base portion and an upper portion.

Current production motor vehicles, such as the modern-day automobile, are originally equipped with driver-side, passenger-side and rear bench-style seat assemblies for comfortably seating the occupants of the vehicle. A vehicle seat assembly may be composed of an internal skeletal seat frame that is mounted to the vehicle body, for example, via a fore-and-aft slide rail assembly. Foam cushions overlay and attach to complementary wire suspension segments of the framework to separate the occupant from the rigid seat frame. Flexible covers, such as fabric, leather, or vinyl trim, conceal any readily visible segments of the frame and the foam cushions to form the occupiable exterior surfaces of the seat. Driver-side and passenger-side front seat assemblies can be typified by an upper, generally vertical backrest portion that is tiltable relative to a lower, generally horizontal seat portion.

Typically, seat assemblies are unique to each model of vehicle in production. For example, a smaller sports car may have lower and narrower vehicle seat while an SUV may have a higher and larger vehicle seat.

Accordingly, it is desirable to provide vehicle seats and methods for producing vehicle seats that utilize a universal base portion for a variety of vehicles, and with dedicated upper portions configured to mate with the universal base portion. Furthermore, other desirable features and characteristics of the present disclosure will become apparent from the subsequent detailed description and the appended claims, taken in conjunction with the accompanying drawings and the foregoing introduction.

### SUMMARY

In one embodiment, a method for producing vehicle seats includes forming a lot of universal foam support bases, wherein each universal foam support base has a base compression strength, wherein each universal foam support base has an upper surface and a lower surface, and wherein the lower surface is configured for mounting to a vehicle seat frame; determining desired parameters for a desired vehicle seat; constructing pieces of trim to form an outer surface for the desired vehicle seat; contacting each piece of trim with a foam material to form intermediate products, wherein each intermediate product includes a foam layer and a trim layer, wherein the foam layer has a thickness of at least forty millimeters, and wherein the foam layer has an upper compression strength less than the base compression strength; processing the intermediate products to form molded upper seat portions having a uniform shape, wherein a thickness of each intermediate product ranges from less than ten millimeters to at least forty millimeters; and mounting each molded upper seat portion directly to the upper surface of a respective universal foam support base to form the vehicle seats having the desired parameters.

In certain embodiments, the method further includes determining second desired parameters for a second desired vehicle seat; constructing second pieces of trim to form the outer surface for the second desired vehicle seat; contacting each second piece of trim with the foam material to form second intermediate products, wherein each second intermediate product includes a second foam layer and a second trim layer, wherein the second foam layer has a second thickness of at least forty millimeters, and wherein the second foam layer has a second upper compression strength less than the base compression strength; processing the second intermediate products to form second molded upper seat portions having a second uniform shape, wherein a second thickness of each intermediate product ranges from less than ten millimeters to at least forty millimeters; and mounting each second molded upper seat portion directly to the upper surface of a respective second universal foam support base to form the second desired vehicle seat having the second desired parameters.

In certain embodiments of the method, contacting the piece of trim with the foam material to form the intermediate product includes pouring a liquid foam onto the piece of trim.

In certain embodiments of the method, contacting the piece of trim with the foam material to form the intermediate product includes placing a sheet of foam onto the piece of trim.

In certain embodiments of the method, processing the intermediate product to form the molded upper seat portion includes molding the intermediate product.

In certain embodiments of the method, processing the intermediate product to form the molded upper seat portion includes thermoforming the intermediate product.

In certain embodiments, the method further includes fitting a respective vehicle seat in a frame structure located in a vehicle.

In certain embodiments of the method, each universal foam support base has a peripheral edge; each molded upper seat portion has a hook portion; and mounting each molded upper seat portion directly to the upper surface of a respective universal foam support base to form the vehicle seats having the desired parameters includes engaging the respective hook portion and peripheral edge.

In certain embodiments of the method, the universal foam support base and the foam material are polyurethane.

In another embodiment, a seat for a vehicle is provided. The seat includes a universal foam support base having an upper surface, wherein the universal foam support base has a first compression strength; a molded upper seat portion mounted directly to the upper surface of the universal foam support base, wherein the molded upper seat portion includes: a trim layer forming an outer surface of the seat; and a foam layer having a second compression strength less than the first compression strength, wherein a thickness of the foam layer varies from less than ten millimeters to at least forty millimeters.

In certain embodiments of the seat, the universal foam support base is fitted to and engaged with a frame structure located in the vehicle.

In certain embodiments of the seat, the foam layer is formed by pouring a liquid foam onto the trim layer.

In certain embodiments of the seat, the foam layer is formed by placing a sheet of foam onto the trim layer.

In certain embodiments of the seat, the foam layer and the trim layer are processed together to form a molded upper seat portion.

In certain embodiments of the seat, the foam layer and the trim layer are thermoformed together.

In certain embodiments of the seat, the universal foam support base has a peripheral edge; the molded upper seat portion has a hook portion; and the molded upper seat portion is mounted directly to the upper surface of the universal foam support base by the hook portion engaging the peripheral edge of the universal foam support base.

In certain embodiments of the seat, the universal foam support base and the foam layer are polyurethane.

In another embodiment, a vehicle is provided and includes a cabin floor; a frame structure mounted to the cabin floor; and a vehicle seat engaging the frame structure, the vehicle seat including: a universal foam support base having an upper surface, wherein the universal foam support base has a first compression strength; a molded upper seat portion mounted directly to the upper surface of the universal foam support base, wherein the molded upper seat portion includes: a trim layer forming an outer surface of the seat; and a foam layer having a second compression strength less than the first compression strength, wherein a thickness of the foam layer varies from less than ten millimeters to at least forty millimeters.

In certain embodiments of the vehicle, the universal foam support base and the foam layer are polyurethane.

In certain embodiments of the vehicle, the universal foam support base has a peripheral edge; the molded upper seat portion has a hook portion; and the molded upper seat portion is mounted directly to the upper surface of the universal foam support base by the hook portion engaging the peripheral edge of the universal foam support base.

### DESCRIPTION OF THE DRAWINGS

The present disclosure will hereinafter be described in conjunction with the following drawing figures, wherein like numerals denote like elements, and wherein:

FIG. 1 is functional block diagram of a vehicle including a seat in accordance with an example;

FIG. 2 is a side view of a vehicle seat frame in the vehicle of FIG. 1, in accordance with exemplary embodiments;

FIG. 3 is a cross sectional schematic view of a vehicle seat received in the seat frame of FIGS. 1 and 2, in accordance with exemplary embodiments;

FIG. 4 is a cross sectional schematic view of a molded upper seat portion of the vehicle seat of FIG. 3.

FIG. 5 is a cross sectional schematic view of a universal foam support base of the vehicle seat of FIG. 3.

FIG. 6 is a flow chart of a method for producing vehicle seats.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, brief summary or the following detailed description.

Certain embodiments provide a modular seat system that contains a common lower padding support base (which interfaces with the seat frame/suspension) that is mated to an interchangeable upper A-Surface (STO) padding unit of incorporated molded trim where the A-Surface can come in variable shapes and surface trims. The lower base layer may be common across multiple seat styles for economy of scale, and will mate and interface with the frame structure and associated common components, such as suspensions, etc. The lower base layer may be tuned for comfort support, such as proving firmness to prevent bottoming out against a metal subsurface. This base layer may be foam, or thermoformed fibers, or a bladder system. There may be variants of the base layer to accommodate vented seats versus non-vented seats.

The upper A-Surface layer can be of multiple shapes and designs, and is meant to mate with the lower base layer like a mix-and-match “hat on a head” system. The upper A-Surface layer includes a molded trim, where there is a decorative aesthetic surface (trim such as vinyl or polyurethane or cloth) with a comfort backing formed into a variable thickness and contours to create a desired A-Surface design. The composite of trim and soft backing material may be molded or thermoformed. Thickness of the upper A-Surface Layer may vary from 3 mm to 50+ mm. The soft backing material may be polyurethane foam, thermoplastic fibers, or other suitable material.

Embodiments herein are provided to improve vehicle seat comfort and performance. Further, embodiments herein provide for the production of vehicle seats that are custom-designed for specific vehicle models, while utilizing a universal base support applicable to a number of vehicle models.

In certain embodiments, a frame structure for supporting a vehicle seat is provided across a line of different vehicle models. In other words, different vehicles are provided with a same frame design. Further, a universal foam support base is configured for mounting to an upper surface of the frame. Lastly, a molded upper seat portion is designed with a desired shape and size, which may be unique for each specific vehicle model. In other words, each vehicle model may be provided with a dedicated molded upper seat portion. Each design of the molded upper seat portion is configured to be mounted or attached to the universal foam support base.

The universal foam support bases and dedicated molded upper seat portions may be fabricated and then assembled to form the desired vehicle seat, and then installed in the frame in a vehicle.

Embodiments herein provide for enhanced comfort. For example, the universal foam support bases may be formed with a first firmness, and each dedicated molded upper seat portion may be formed with a second firmness that is less than the first firmness. Embodiments herein may provide for increased quality, as two opposing A-surfaces are mounted together. For example, a lower seat portion may be molded with an exposed bottom STO surface, commonly referred to as the B-surface, in the bottom bowl of the foam tool. Thus, liquid polyurethane may be poured directly onto the surface that forms the B-surface of the lower seat portion of the quality equal to that of a conventional A-surface. Also, embodiments herein may reduce cost as a benefit from use of a universal foam support base across vehicle models due to economy of scale.

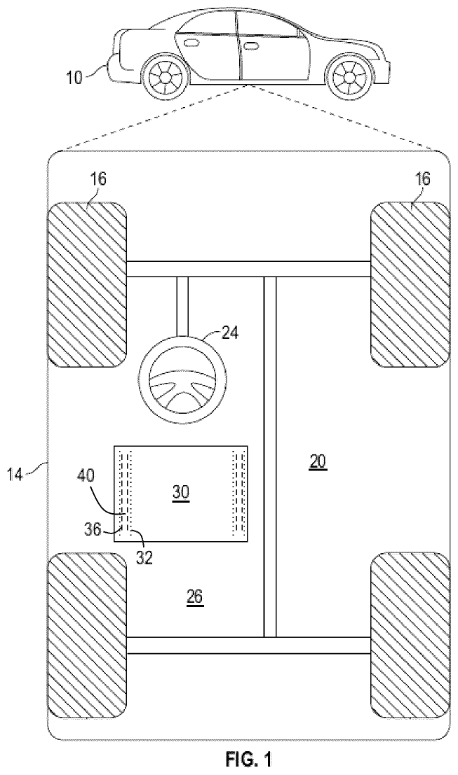

With reference to FIG. 1, certain features of a vehicle 10 are illustrated in functional block diagram form. It is noted that the connecting lines shown in the various figures contained herein are intended to represent example functional relationships and/or physical couplings between the various elements. It should be noted that many alternative or additional functional relationships or physical connections may be present in an embodiment of the present disclosure.

In certain examples, the vehicle 10 comprises an automobile. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

As depicted in FIG. 1, the exemplary vehicle 10 generally includes a body 14 and wheels 16. The body 14 substantially encloses components of the vehicle 10. The body 14 may define an internal cabin 20 having a cabin floor 26. The wheels 16 are each rotationally coupled to the vehicle 10 near a respective corner of the body 14.

The vehicle 10 further includes a steering wheel 24 and a vehicle seatback 30 distanced from the steering wheel 24 in a longitudinal direction. As indicated, vehicle base tracks 32 may be mounted to the cabin floor 26. Further, seat rails 36 may cooperate with the vehicle base tracks 32 for provide for sliding engagement. The base tracks 32 and/or seat rails 36 may form a vehicle seat frame or frame structure 40.

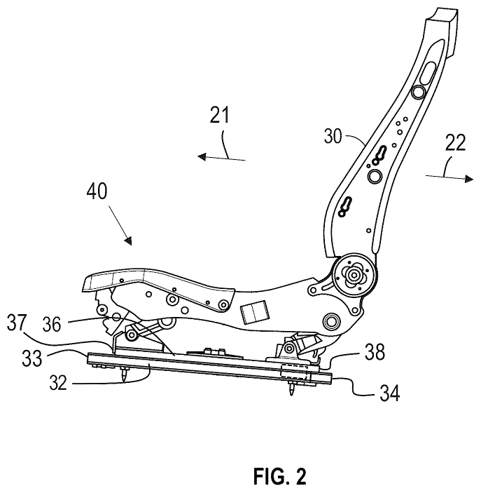

FIG. 2 illustrates the engagement and positioning of the frame structure 40, seat rail 36, and vehicle base track 32.

As shown in FIG. 2, the vehicle base track 32 extends from a front end 33 to a rear end 34. Further, the seat rail 36 extends from a front end 37 to a rear end 38. The frame 40 and seat rail 36 may move in a forward direction 21 to the front end 33 or in a rearward direction 22 to the rear end 34.

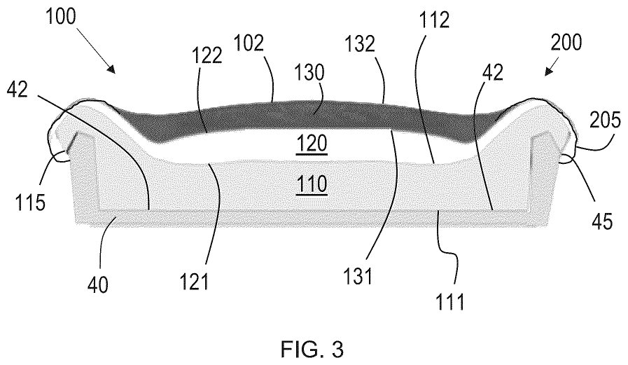

FIG. 3 is a cross sectional schematic view of a vehicle seat 100 for use with the frame 40 of FIG. 2. As shown, the frame 40 has an upper surface 42 and an outer perimeter 45.

In FIG. 3, the vehicle seat 100 includes a universal foam support base 110. As shown, the universal foam support base 110 has a lower surface 111 and an upper surface 112. In certain embodiments, the universal foam support base 110 is formed from polyurethane, polyethylene terephthalate (PET), linear low-density polyethylene, or other suitable materials.

Also, the vehicle seat 100 includes a foam layer 120. The foam layer 120 has a lower surface 121 and an upper surface 122. In certain embodiments, the universal foam support base 110 is formed from polyurethane, polyethylene terephthalate (PET), linear low-density polyethylene, or other suitable materials.

In certain embodiments, the universal foam support base 110 is more firm than the foam layer 120. Such an arrangement may provided for added comfort. When evaluating a foam product for use in a comfort application, compression strength may be used. Compression strength rates the feel and firmness of a foam material by testing how the foam material yields to or supports applied weight. Compression strength values may be used to categorize foam materials.

Compression strength is typically evaluated through a test called Compression Force Deflection (CFD), also known as Compression Load Deflection (CLD). This is a performance evaluation, with standardization allowing all materials tested using this process to be measured against each other. There are multiple ways foam strength is tested, but the most prevalent is the 40 percent compression test per ISO 3386-1 test procedure. Typically, this test is performed with a foam sample size of 25 millimeters thick, 50 millimeters wide and 50 millimeters long. Maintaining this consistency across every test is important because foam materials can bear weight and pressure differently depending on thickness and size, even if the sample is cut from the same bulk material. Thinner sections of foam will yield more easily to weight while thicker sections will be more resilient. Additionally, testing products of different dimensions eliminates the test's control and, in turn, the ability to evenly compare results from one material to another.

The lowest CFD values indicate the softest and most cushioning foams, as they require the fewest kilopascals to be compressed. CFD in the 3 kilopascals to 8 kilopascals range generally mean the foam carries a balance of comfort and support. CFD values of 9 kilopascal and greater are the most supportive and firm foam materials. These are most commonly used in seating cushions that bear the full weight of a body centered on a smaller area, automobile seating.

In addition to the standard 40 percent test, there are additional compression strength evaluations that provide more insight into a material. Frequently included along with the 40 percent CFD data is a 50 percent compression value, which is a measure of the kilopascals required to compress a foam sample half of its height, or 25 percent compression value, which is a measure of the kilopascals required to compress a foam sample quarter of its height. This is tested because compression is not necessarily linear, so you cannot simply multiply the 40 percent compression value to know how it responds to greater or lower force. Many types of foam have similar 40 percent CFDs but very different 25 percent CFDs.

Yet another test is support factor, which may also be called sag factor or compression modulus. This value is a comparison ratio between the 25 percent compression value and a deeper 65 percent degree of compression. The 25 percent value is divided into the 65, typically resulting in a value from 1 to 3 that more accurately represents support capability than a single test. Because foam is going to be compressed by 65 percent more often in real-world use than 25 percent, this combination generates a performance value while still utilizing the 25 percent CFD. The greater the support factor value, the more supportive the material is.

In embodiments herein, the universal foam support base 110 has a greater compression strength than the foam layer 120. For example, the universal foam support base 110 may have a 40% CFD that is from 1.1 to 2.0 times greater than the 40% CFD of the foam layer 120. For example, the universal foam support base 110 may have a 40% CFD that is from 1.2 to 1.5 times greater than the 40% CFD of the foam layer 120. Also, the composite of the foam layer 120 and the universal foam support base 110 may have a combined support factor that is at least at least 1.6, at least 1.7, at least 1.8 at least 1.9, at least 2, at least 2.5, at least 3, at least 4, or at least 5.

Further, the vehicle seat 100 includes a trim layer 130. The trim layer 130 includes a lower surface 131 and an upper surface 132. In certain embodiments, the trim layer 130 is formed from a finished material such as leather, faux leather, vinyl, fabric, or other suitable material.

The foam layer 120 and trim layer 130 collectively form a molded upper seat portion 200. The molded upper seat portion 200 includes an outer edge 205. As shown in FIG. 3, the outer edge 205 may form a hook portion that engages the perimeter 45 of the frame 40 and/or the periphery 115 of the universal foam support base 110.

As shown in FIG. 3, the bottom surface 111 of the universal foam support base 110 fits in or engages the upper surface 42 of the frame 40. The bottom surface 121 of the foam layer 120 fits in or engages the upper surface 112 of the universal foam support base 110.

The bottom surface 131 of the trim layer 130 fits in or engages the upper surface 122 of the foam layer 120. Further, the upper surface 132 of the trim layer 130 forms the outer surface 102 of the vehicle seat 100.

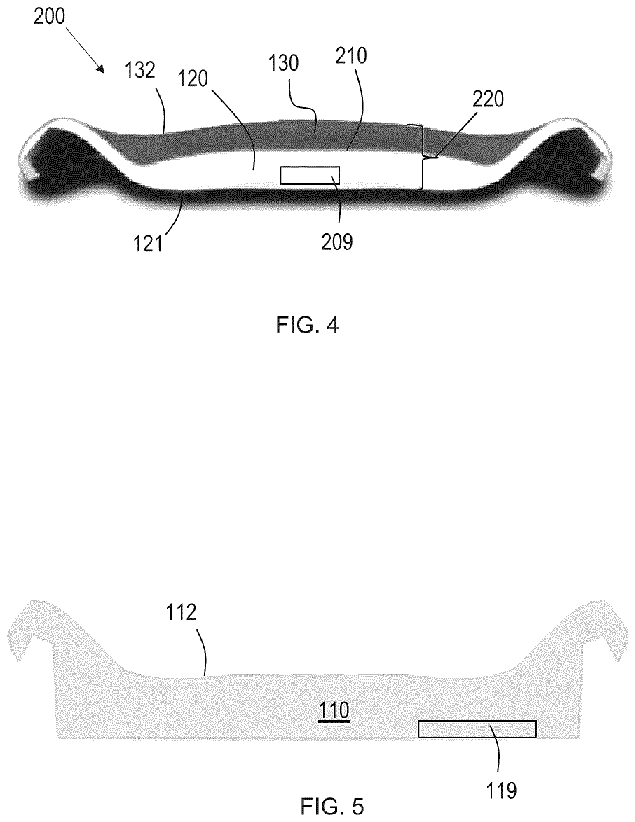

FIG. 4 illustrates the molded upper seat portion 200 formed from the foam layer 120 and the trim layer 130. As shown, the molded upper seat portion 200 has a varying vertical thickness 220. For example, at a thick region, the molded upper seat portion 200 may have a greatest thickness, or a maximum thickness, from bottom surface 121 to upper surface 132. At a thin region, the molded upper seat portion 200 may have a smallest thickness, or a minimum thickness, from bottom surface 121 to upper surface 132.

In certain embodiments, the maximum thickness is at least 30 millimeters (mm), such as at least 35 mm, at least 40 mm, at least 45 mm, or at least 50 mm. In certain embodiments, the maximum thickness is no more than 60 mm, such as no more than 55 mm, no more than 50 mm, no more than 45 mm, no more than 40 mm, or no more than 35 mm.

In certain embodiments, the minimum thickness is at least 1 mm, such as at least 2 mm, at least 3 mm, at least 4 mm, at least 5 mm, at least 6 mm, at least 7 mm, at least 8 mm, or at least 10 mm. In certain embodiments, the minimum thickness is no more than 20 mm, such as no more than 15 mm, no more than 10 mm, no more than 9 mm, no more than 8 mm, no more than 7 mm, no more than 6 mm, no more than 5 mm, no more than 4 mm, or no more than 3 mm.

Thus, the molded upper seat portion 200 may have a thickness differential equal to the difference between the maximum thickness and the minimum thickness. In certain embodiments, the molded upper seat portion 200 has a thickness differential of at least 20 mm, such as at least 25 mm, at least 30 mm, at least 31 mm, at least 32 mm, at least 33 mm, at least 34 mm, at least 35 mm, at least 36 mm, at least 37 mm, at least 38 mm, at least 39 mm, at least 40 mm, at least 41 mm, at least 42 mm, at least 43 mm, at least 44 mm, at least 45 mm, at least 46 mm, at least 47 mm, at least 48 mm, at least 49 mm, or at least 50 mm.

FIG. 5 illustrates the universal foam support base 110. Cross-referencing FIGS. 4 and 5, the molded upper seat portion 200 is designed and configured to be received on the upper surface 112 of the universal foam support base 110. Specifically, the universal foam support base 110 may be designed and fabricated such that the upper surface 112 has a known size and contour. Thus, each individualized or dedicated molded upper seat portion 200 is formed with a universal bottom surface 121 that mates with the upper surface 112.

It is noted that haptic components 119 may be incorporated onto the universal foam support base 110 to provide haptic feedback to the vehicle operator or passengers. Further, heating components 209 may be incorporated into the molded upper seat portion 200. The heating components 209 may include heating elements and/or ventilation elements.

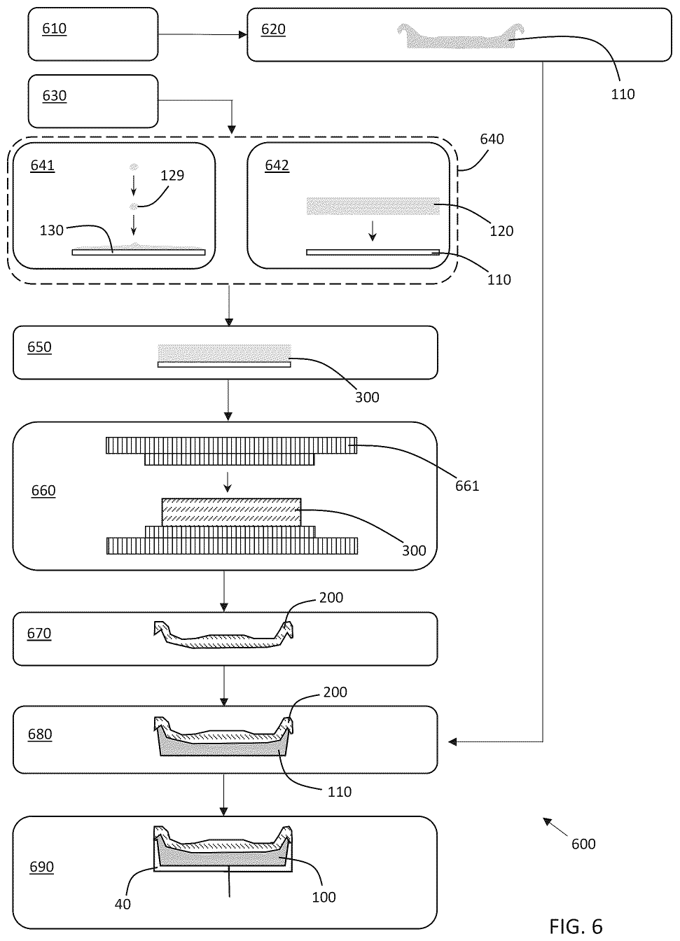

FIG. 6 illustrates a method 600 for producing vehicle seats. As shown, method 600 may include, at 610, designing and fabricating a universal foam support base 110. For example, a universal foam support base 110 may be designed for engagement with and mounting to a standardized frame structure 40.

Method 600 may include, at 620, storing a lot of fabricated universal foam support bases 110

Method 600 includes, at 630, determining desired parameters for a molded upper seat portion 200. For example, the space available in a vehicle and other design considerations may be evaluated to determine the shape and size of the vehicle seat, and the shape and size of the molded upper seat portion 200 needed to form such a vehicle seat.

At 640, method 600 may form an intermediate product 300 including a foam layer 120 and trim layer 130. For example, as shown at 641, a trim layer 130 may be selected and cut from a trim material with the desired area. Then, a liquid foam material 129 may be poured onto the trim layer 130 to form a foam layer 120. Alternatively, a solid foam layer 120 may be cut from foam material and placed onto the trim layer 130 at 642.

At 650, method 600 transports the intermediate product 300 for further processing.

For example, at 660, method may shape the intermediate product 300 into the desired form of the molded upper seat portion 200 with the appropriate machine 661. At 660, method 600 may use a thermoforming process or a molding process to shape the intermediate product 300 into the desired form of the molded upper seat portion 200.

At 670, the molded upper seat portion 200 may be removed from the machine 661 and stored or transported for later use.

At 680, method 600 may continue with placing the molded upper seat portion 200 onto a universal foam support base 110. As noted above, the molded upper seat portion 200 may be formed with a hook portion that engages the universal foam support base 110. Alternatively or additionally, the molded upper seat portion 200 may be adhered to the universal foam support base 110 at the interface therebetween.

At 690, method 600 includes engaging the universal foam support base 110 with the frame structure 40 of the vehicle 10, such as to install the vehicle seat 100 in the vehicle 10.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for producing vehicle seats, the method comprising:
forming a lot of universal foam support bases, wherein each universal foam support base has a base compression strength, wherein each universal foam support base has an upper surface and a lower surface, and wherein the lower surface is configured for mounting to a vehicle seat frame;
determining desired parameters for a desired vehicle seat;
constructing pieces of trim to form an outer surface for the desired vehicle seat;
contacting each piece of trim with a foam material to form intermediate products, wherein each intermediate product includes a foam layer and a trim layer, wherein the foam layer has a thickness of at least forty millimeters, and wherein the foam layer has an upper compression strength less than the base compression strength;
processing the intermediate products to form molded upper seat portions having a uniform shape, wherein a thickness of each intermediate product ranges from less than ten millimeters to at least forty millimeters; and
mounting each molded upper seat portion directly to the upper surface of a respective universal foam support base to form the vehicle seats having the desired parameters.

2. The method of claim 1, further comprising:
determining second desired parameters for a second desired vehicle seat;
constructing second pieces of trim to form the outer surface for the second desired vehicle seat;
contacting each second piece of trim with the foam material to form second intermediate products, wherein each second intermediate product includes a second foam layer and a second trim layer, wherein the second foam layer has a second thickness of at least forty millimeters, and wherein the second foam layer has a second upper compression strength less than the base compression strength;
processing the second intermediate products to form second molded upper seat portions having a second uniform shape, wherein a second thickness of each intermediate product ranges from less than ten millimeters to at least forty millimeters; and
mounting each second molded upper seat portion directly to the upper surface of a respective second universal foam support base to form the second desired vehicle seat having the second desired parameters.

3. The method of claim 1, wherein contacting the piece of trim with the foam material to form the intermediate product comprises pouring a liquid foam onto the piece of trim.

4. The method of claim 1, wherein contacting the piece of trim with the foam material to form the intermediate product comprises placing a sheet of foam onto the piece of trim.

5. The method of claim 1, wherein processing the intermediate product to form the molded upper seat portion comprises molding the intermediate product.

6. The method of claim 1, wherein processing the intermediate product to form the molded upper seat portion comprises thermoforming the intermediate product.

7. The method of claim 1, further comprising fitting a respective vehicle seat in a frame structure located in a vehicle.

8. The method of claim 1, wherein:
each universal foam support base has a peripheral edge;
each molded upper seat portion has a hook portion; and
mounting each molded upper seat portion directly to the upper surface of a respective universal foam support base to form the vehicle seats having the desired parameters comprises engaging the respective hook portion and peripheral edge.

9. The method of claim 1, wherein the universal foam support base and the foam material are polyurethane.

10. A seat for a vehicle, the seat comprising:
a universal foam support base having an upper surface, wherein the universal foam support base has a first compression strength;
a molded upper seat portion mounted directly to the upper surface of the universal foam support base, wherein the molded upper seat portion comprises:
a trim layer forming an outer surface of the seat; and
a foam layer having a second compression strength less than the first compression strength, wherein a thickness of the foam layer varies from less than ten millimeters to at least forty millimeters.

11. The seat of claim 10, wherein the universal foam support base is fitted to and engaged with a frame structure located in the vehicle.

12. The seat of claim 10, wherein the foam layer is formed by pouring a liquid foam onto the trim layer.

13. The seat of claim 10, wherein the foam layer is formed by placing a sheet of foam onto the trim layer.

14. The seat of claim 10, wherein the foam layer and the trim layer are processed together to form a molded upper seat portion.

15. The seat of claim 14, wherein the foam layer and the trim layer are thermoformed together.

16. The seat of claim 14, wherein:
the universal foam support base has a peripheral edge;
the molded upper seat portion has a hook portion; and
the molded upper seat portion is mounted directly to the upper surface of the universal foam support base by the hook portion engaging the peripheral edge of the universal foam support base.

17. The seat of claim 10, wherein the universal foam support base and the foam layer are polyurethane.

18. A vehicle comprising:
a cabin floor;
a frame structure mounted to the cabin floor; and
a vehicle seat engaging the frame structure, the vehicle seat comprising:
a universal foam support base having an upper surface, wherein the universal foam support base has a first compression strength;
a molded upper seat portion mounted directly to the upper surface of the universal foam support base, wherein the molded upper seat portion comprises:
a trim layer forming an outer surface of the vehicle seat; and
a foam layer having a second compression strength less than the first compression strength, wherein a thickness of the foam layer varies from less than ten millimeters to at least forty millimeters.

19. The vehicle of claim 18, wherein the universal foam support base and the foam layer are polyurethane.

20. The vehicle of claim 18, wherein:
the universal foam support base has a peripheral edge;
the molded upper seat portion has a hook portion; and
the molded upper seat portion is mounted directly to the upper surface of the universal foam support base by the hook portion engaging the peripheral edge of the universal foam support base.
